(19) United States
(12) Patent Application Publication
(10) Pub. No.: US 2006/0198391 A1
(43) Pub. Date: Sep. 7, 2006

(54) Method for forming synchronous data in residential ethernet system

(75) Inventors: Sang-Ho Kim, Hwanseong-si (KR); Jae-Hun Cho, Seoul (KR); Kwan-Soo Lee, Seoul (KR); Yun-Jo Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD.

(21) Appl. No.: 11/367,242

(22) Filed: Mar. 3, 2006

(30) Foreign Application Priority Data
Mar. 3, 2005 (KR) 2005-17852

(51) Int. Cl. H04J 3/16

(52) U.S. Cl. 370/466; 370/470

(57) ABSTRACT

Disclosed is a method for forming a synchronous frame to be transmitted in a Residential Ethernet System, which is capable of discretely transmitting synchronous data and asynchronous data, wherein the synchronous frame includes synchronous packets which are formed according to destinations of synchronous data. The method includes the steps of: receiving the synchronous data having different destinations, and classifying the received synchronous data according to the destinations of the synchronous data; adding a synchronous header to each of the synchronous data classified according to the destinations in order to insert synchronous information into each synchronous data; and adding an Ethernet header for Ethernet processing, thereby forming the synchronous packets.

### CLAIM OF PRIORITY

This application claims the benefit of an application entitled “Method For Forming Synchronous Data In Residential Ethernet System,” filed in the Korean Intellectual Property Office on Mar. 3, 2005 and assigned Ser. No. 2005-17852, the entire contents of which are incorporated herein by reference.

### BACKGROUND OF THE INVENTION

1. Field of the Invention

The present invention relates to a Residential Ethernet, and more particularly to a method of transmitting synchronous data through a packet-based routing in the Residential Ethernet.

2. Description of the Related Art

Ethernet is the most widely used local area network technology which is defined in a standard from an Institute of Electrical and Electronics Engineers (IEEE) 802.3. In the conventional Ethernet, since an access is achieved by means of a carrier sense multiple access/collision detect (CSMA/CD) protocol stipulated in an IEEE 802.3, a service frame of an upper layer is converted to an Ethernet frame while maintaining an inter frame gap (IFG) during transmission of the Ethernet frames. The upper service frames are transmitted according to a sequence of generation thereof regardless of the frame type. Hence, the Ethernet is generally used when data is transmitted among a plurality of terminals or users.

Ethernet has been known to be insufficient for transmitting a moving image or voice data susceptible to a transmission delay as the Ethernet employs the CSMA/CD scheme in which every Ethernet frame is given the same priority for transmission. Recently, various methods have been proposed for removing such a problem caused by the transmission delay using the Ethernet scheme.

IEEE 802.3p is one scheme conventionally-proposed in order to reduce time delay in the Ethernet. According to the IEEE 802.3p, classification of service (COS) is allocated to data such as multimedia data, to which priority must be given. The IEEE 802.3p scheme provides a slightly improved effect with respect to time delay by allocating a priority to multimedia data or the like to be transmitted, as compared with the conventional IEEE 802.3 Ethernet scheme. However, since the IEEE 802.3p scheme does not employ a process of requiring and allocating a bandwidth to each data, a bandwidth manager for managing the allocation of a bandwidth is required, thereby increasing the size of a jitter buffer for such bandwidth management.

A Residential Ethernet is another conventionally-proposed transmission scheme, in which synchronous data and asynchronous data are discretely transmitted during one transmission cycle. According to the Residential Ethernet, slots of the same size are respectively allocated to synchronous data, so that sub-synchronous frames having the same size are constructed and transmitted.

FIG. 1 is a view illustrating the structure of a transmission cycle in the conventional Residential Ethernet.

The conventional Residential Ethernet has a transmission cycle 10 of 125 μsec, which includes an asynchronous frame section 110 for transmission of asynchronous data and a synchronous frame section 100 for transmission of synchronous data.

In detail, the synchronous frame section 100 for transmission of synchronous data contains data having the highest priority in the transmission cycle. According to a recent proposal, the synchronous frame section 100 includes sub-synchronous frames 101, 102, and 103, each of which is constructed with 738 bytes. Also, the asynchronous frame section 110 for transmission of asynchronous data includes sub-asynchronous frames 111, 112, and 113, each of which have a variable size.

FIG. 2 is a view illustrating the structure of a sub-synchronous frame included in a transmission cycle of the conventional Residential Ethernet.

In conventional Residential Ethernet, a sub-synchronous frame includes an Ethernet header 21, a synchronous header 22, a header check sequence (HCS) field 23, a synchronous data slot field 24, and a frame check sequence (FCS) field 25. The Ethernet header 21 is constructed by 22 octets and contains header information including type information, a destination address, and a source address of a relevant Ethernet frame. The synchronous header 22 is constructed by 32 bytes and contains information about a synchronization frame, such as whether or not the relevant frame is a synchronous frame, frame count information, and cycle count information. The HCS field 23 is used to check header information. The synchronous data slot field 24 is constructed by 768 bytes and contains synchronous Ethernet data to be transmitted, which include 192 4-byte synchronous data slots. The FCS field 25 is used to detect a transmission error.

Also, the synchronous data slot field 24 is constructed by a set of 4-byte data slots 241 and 242, so that each of synchronous Ethernet data is divided into data slots of 4 bytes and is transmitted.

In this case, when synchronous Ethernet data are transmitted from a server to each user, the synchronous data slot field 24 contains synchronous Ethernet data for all users in the form of slots. Therefore, synchronous Ethernet data are transmitted to the users in a multicast scheme, rather than a unicast scheme, so that each user terminal must process data for the user terminal according to data slots.

A destination address included in the Ethernet header 21 is a destination address representing an Ethernet switch for final routing, rather than a destination address of each Ethernet synchronous data. Therefore, the destination address included in the Ethernet header 21 differs from a destination address of Ethemet synchronous data allocated to each user.

FIG. 3 is a view illustrating the structure of a transmission cycle showing each data slot in the conventional Residential Ethernet.

The conventional Residential Ethernet has a transmission cycle 300 of 125 μsec, which is divided into a synchronous frame section including sub-synchronous frames 31, 32, and 33, and an asynchronous frame section including sub-asynchronous frames 34, 35, and 36, as shown in FIG. 1. Particularly, data slots included in the sub-synchronous frames 31, 32, and 33 are inserted into each relevant sub-synchronous frame 31, 32, or 33 while not being classified depending on destinations thereof.

A first sub-synchronous frame 31 contains data 301 to be transmitted to a first user, data 302 to be transmitted to a second user, and data 303 to be transmitted to a third user. Also, a second sub-synchronous frame 32 contains data 304 to be transmitted to a fourth user, and a third sub-synchronous frame 33 contains data 305 to be transmitted to a fifth user and data 306 to be transmitted to a sixth user.

FIG. 4 is a view for explaining a transmission procedure for synchronous data in the conventional Residential Ethernet System.

A Residential Ethernet System includes a server 41, a first Residential Ethernet switch 42, a second Residential Ethernet switch 43, and users 44-1, 44-2, and 44-3. The server 41 provides synchronous data and asynchronous data to be transmitted to the users 44-1, 44-2, and 44-3. The first Residential Ethernet switch 42 constructs a Residential Ethernet transmission cycle 400 and transmits the Residential Ethernet transmission cycle 400 downward. The second Residential Ethernet switch 43 receives the Residential Ethernet transmission cycle 400 and transmits the received Residential Ethernet transmission cycle 400 to the users 44-1, 44-2, and 44-3. Each of the users 44-1, 44-2, and 44-3 receives the Residential Ethernet transmission cycle 400 and processes data destined for himself/herself among the received Residential Ethernet transmission cycle 400. Herein, the user 44-1, 44-2, and 44-3 represent user terminals for user interface.

A transmission procedure for synchronous data in the conventional Residential Ethernet System having the above-mentioned construction is as follows: First, the server 41 generates synchronous data 401, 402, and 403 to be transmitted to the users 44-1, 44-2, and 44-3, respectively, and transmits the synchronous data 401, 402, and 403 to the first Residential Ethernet switch 42.

The first Residential Ethernet switch 42 constructs a Residential Ethernet transmission cycle 400 using the synchronous data 401, 402, and 403, in which the Residential Ethernet transmission cycle 400 includes an asynchronous frame section 400-1 and a synchronous frame section 400-2, as shown in FIG. 1. FIG. 4 shows an example of a Residential Ethernet transmission frame, which is divided into the asynchronous frame section 400-1 and the synchronous frame section 400-2 containing one sub-synchronous frame.

As shown in FIG. 4, all synchronous data 401, 402, and 403 to be transmitted to the users 44-1, 44-2, and 44-3 are gathered in one sub-synchronous frame and then transmitted.

That is, each of the synchronous data 401, 402, and 403 is inserted in a form of data slots into the synchronous data slot field of the sub-synchronous frame, then transmitted.

Therefore, the second Residential Ethernet switch 43 cannot transmit the synchronous data 401, 402, and 403 in a slot unit according to each user 44-1, 44-2, and 44-3, but must transmit the entire synchronous frame section 400-2 in a multicast scheme. Accordingly, each user 44-1, 44-2, and 44-3 processes slot data included in the transmitted synchronous frame section 400-2 in order to receive synchronous data transmitted to himself/herself.

Such a conventional Residential Ethernet System requires a slot data processing with respect to each synchronous data, so that there is a disadvantage in that a complicated procedure of converting each synchronous data into slot data and gathering the converted slot data in the data area of the sub-synchronous frame must be performed. Also, in order to perform a slot routing task and a slot reservation task with respect to the contained slot data, the data area of the sub-synchronous frame must be managed which is a problem in the prior art. In addition, if synchronous data is converted into slot data while an intermediate area is not used, bandwidth is greatly wasted. Furthermore, since the entire synchronous frame section is transmitted to every user, even unnecessary data for each user are transmitted, thereby largely wasting bandwidth.

### SUMMARY OF THE INVENTION

Accordingly, the present invention has been made to solve the above-mentioned problems occurring in the prior art and provides additional advantages, by providing a method for forming synchronous data in a Residential Ethernet System for enabling synchronous data to be independently transmitted to each user without slot processing.

In accordance with one aspect of the present invention, there is provided a method for forming a synchronous frame to be transmitted in a Residential Ethernet System capable of discretely transmitting synchronous data and asynchronous data, wherein the synchronous frame includes synchronous packets which are formed according to destinations of synchronous data. The method includes the steps of: receiving the synchronous data having different destinations, and classifying the received synchronous data according to the destinations of the synchronous data; adding a synchronous header to each of the synchronous data classified according to the destinations in order to insert synchronous information into each synchronous data; and adding an Ethernet header for Ethernet processing, thereby forming the synchronous packets.

### BRIEF DESCRIPTION OF THE DRAWINGS

The above features and advantages of the present invention will be more apparent from the following detailed description taken in conjunction with the accompanying drawings, in which:

FIG. 1 is a view illustrating the structure of a transmission cycle in the conventional Residential Ethernet;

FIG. 2 is a view illustrating the structure of a sub-synchronous frame included in a transmission cycle of the conventional Residential Ethernet;

FIG. 3 is a view illustrating the structure of a transmission cycle in order to explain each data slot in the conventional Residential Ethernet;

FIG. 4 is a view for explaining a transmission procedure for synchronous data in the conventional Residential Ethernet System;

FIG. 5 is a view illustrating the structure of a transmission cycle for explaining each data slot in a Residential Ethernet according to an embodiment of the present invention; and

FIG. 6 is a view for explaining a transmission procedure for synchronous data in the Residential Ethernet System according to an embodiment of the present invention.

### DETAILED DESCRIPTION

Hereinafter, an embodiment according to the present invention will be described with reference to the accompanying drawings. For the purposes of clarity and simplicity, a detailed description of known functions and configurations incorporated herein will be omitted as it may obscure the subject matter of the present invention.

According to the teachings of the present invention, synchronous data of a synchronous frame section, which are divided into slot data in the existing Residential Ethernet, are packetized depending on the destination of each synchronous data, so that synchronous packets have various sizes and can be routed according to each synchronous packet.

The present invention will now be described in detail with reference to the accompanying drawings.

FIG. 5 is a view illustrating the structure of a transmission cycle showing each data slot in a Residential Ethernet according to. an embodiment of the present invention.

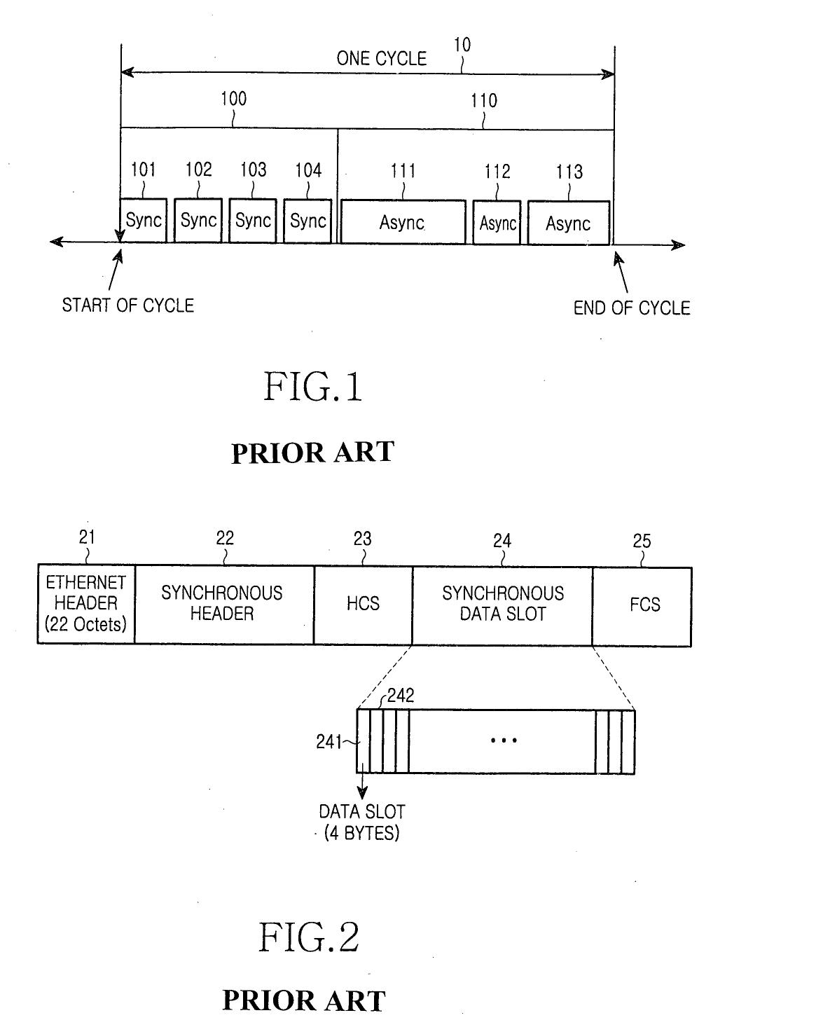

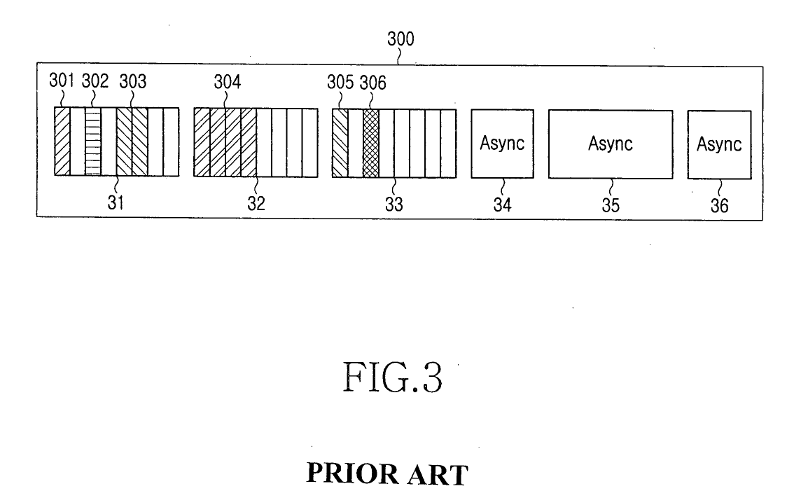

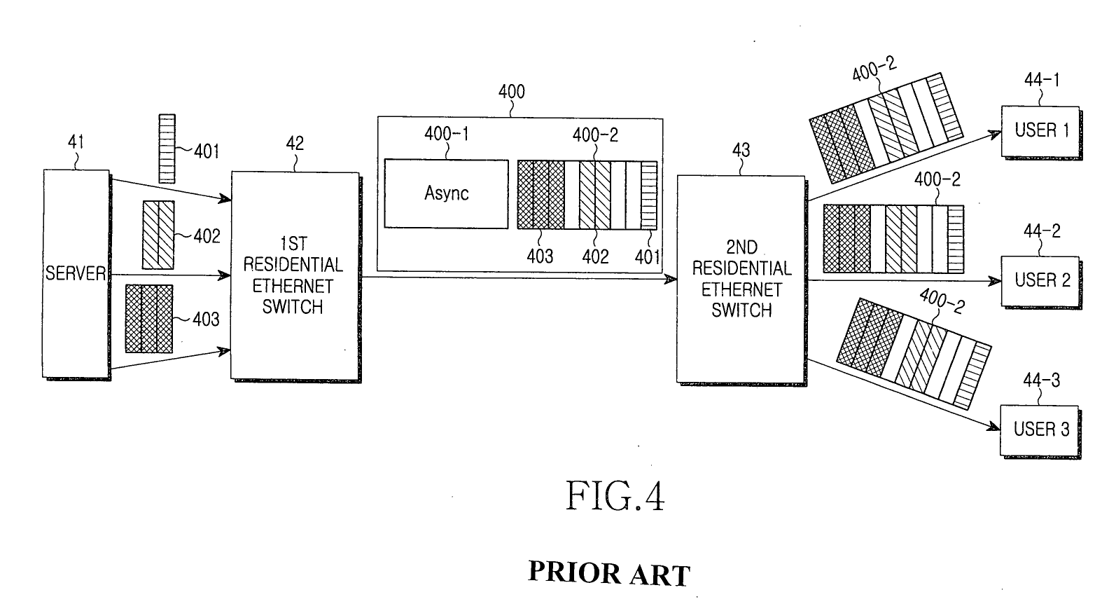

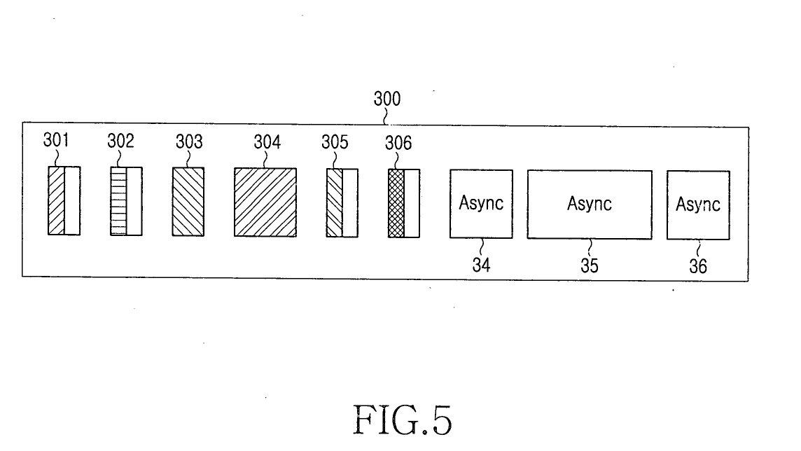

The Residential Ethernet according to an embodiment of the present invention has a transmission cycle 300 of 125 μsec, which includes an asynchronous frame section and a synchronous frame section, as shown in FIG. 1.

Herein, while the asynchronous frame section contains sub-asynchronous frames 34, 35, and 36, as that in the prior art, the synchronous frame section contains packets grouped according to their destination. That is, packets in the Residential Ethernet according to the present invention have non-uniform sizes.

More particularly, each of data 301 to be transmitted to a first user, data 302 to be transmitted to a second user, data 303 to be transmitted to a third user, data 304 to be transmitted to a fourth user, data 305 to be transmitted to a fifth user, and data 306 to be transmitted to a sixth user is constructed as one packet.

Referring back to FIG. 2, in the present invention, each packet includes an Ethernet header 21 constructed by 22 octets so as to include Ethernet information, a synchronous header 22 including synchronous information of a synchronous frame, a header check sequence (HCS) field 23, and a frame check sequence (FCS) field 25 for detecting a transmission error. In this case, the Ethernet header 21 or synchronous header 22 includes information about the destination of each relevant packet.

Since synchronous data are packetized according to their destination, each synchronous data can be transmitted in a unicast scheme, rather than a multicast scheme, which was used in the conventional Residential Ethernet.

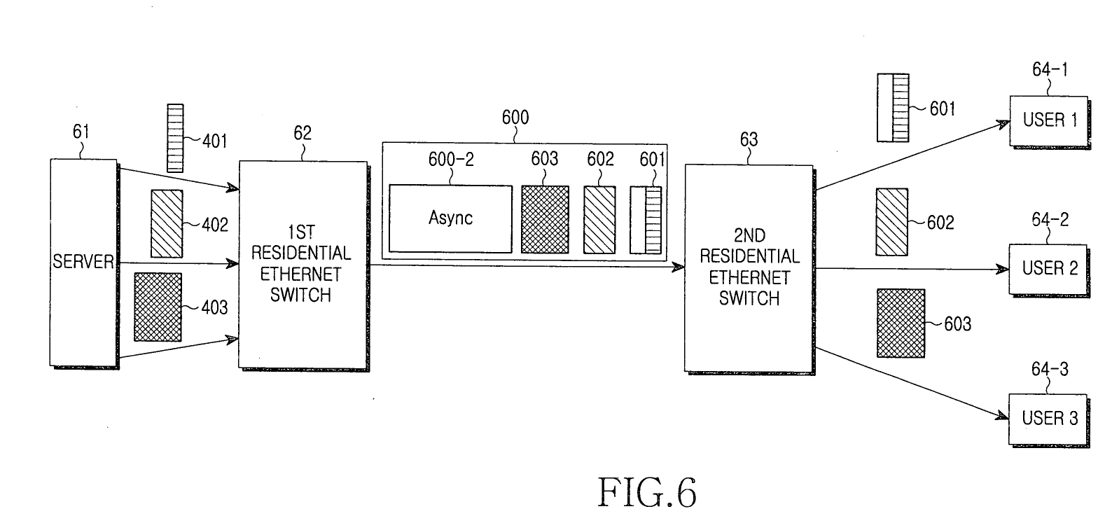

FIG. 6 is a view for explaining a transmission procedure for synchronous data in the Residential Ethernet System according to an embodiment of the present invention.

A Residential Ethernet System includes a server 61, a first Residential Ethernet switch 62, a second Residential Ethernet switch 63, and users 64-1, 64-2, and 64-3. The server 61 provides synchronous data and asynchronous data to be transmitted to the users 64-1, 64-2, and 64-3. The first Residential Ethernet switch 62 constructs a Residential Ethernet transmission cycle 600 according to an embodiment of the present invention, and transmits the Residential Ethernet transmission cycle 600 downward. The second Residential Ethernet switch 63 receives the Residential Ethernet transmission cycle 600, and transmits each synchronous packet included in the received Residential Ethernet transmission cycle 600 to the users 64-1, 64-2, or 64-3 corresponding to the destination of each synchronous packet. Each of the users 64-1, 64-2, and 64-3 receives and processes a synchronous packet. Herein, the user 64-1, 64-2, and 64-3 represent user terminals for user interface.

A transmission procedure for synchronous data in the Residential Ethernet System according to an embodiment of the present invention is as follows: First, the server 61 generates synchronous data 401, 402, and 403 to be transmitted to the users 64-1, 64-2, and 64-3, respectively, and transmits the synchronous data 401, 402, and 403 to the first Residential Ethernet switch 62.

The first Residential Ethernet switch 62 constructs a Residential Ethernet transmission cycle 600 using the synchronous data 401, 402, and 403, in which the Residential Ethernet transmission cycle 600 includes an asynchronous frame section 600-2 and synchronous packets 601, 602, and 603 grouped according to each user.

Herein, the synchronous packets 601, 602, and 603 grouped according to each user are constructed in such a manner that the first Residential Ethernet switch 62 receives synchronous data having a different destination according to each user, classifies the received synchronous data according to each destination, attaches a synchronous header to each synchronous data classified according to its destination in order to insert synchronous information into each synchronous data, and adds Ethernet information for Ethernet processing to each synchronous data to which a synchronous header is attached. In this case, an HCS field for preventing an error in header construction and/or an FCS for detecting a transmission error may be added.

Since information about each destination is included in an Ethernet header or synchronous header, packets can be routed even with only header information without checking a payload section, differently from conventional Residential Ethernet.

Thereafter, the second Residential Ethernet switch 63 transmits each of the synchronous packet 601, 602, and 603 to corresponding user 64-1, 64-2, and 64-3, respectively, in a unicast scheme.

Note that the method according to the present invention can be realized by a program and can be stored in a recording medium (such as a CD ROM, a RAM, a floppy disk, a hard disk, a magneto-optical disk, etc.) in a format that can be read by a computer.

According to the present invention as described above, since the Residential Ethernet System constructs the synchronous frame in a packet unit, a complicated procedure of converting synchronous data into slot data is not required. Further, it is unnecessary to manage the data area of a sub-synchronous frame which has been required for a slot routing task and a slot reservation task with respect to the slot data in the prior art.

Moreover, differently from the conventional Residential Ethernet System in which frames are constructed in the same size, the Residential Ethernet System according to the present invention allows packets to be constructed in different sizes, thereby reducing waste of bandwidth.

Furthermore, according to the Residential Ethernet System of the present invention, since synchronous data can be transmitted to each user according to their destination in a unicast scheme, the transmission of unnecessary data is prevented, thereby preventing waste of bandwidth with respect to each user.

While the present invention has been shown and described with reference to certain preferred embodiments thereof, it will be understood by those skilled in the art that various changes in form and details may be made therein without departing from the spirit and scope of. the invention as defined by the appended claims. Accordingly, the scope of the invention is not to be limited by the above embodiments but by the claims and the equivalents thereof.

What is claimed is:

1. A method for forming a synchronous frame to be transmitted in a Residential Ethernet System capable of discretely transmitting synchronous data and asynchronous data, the method comprising the steps of:
receiving synchronous data having different destinations and classifying the received synchronous data according to destinations of the synchronous data;
adding a synchronous header to each of the classified synchronous data in order to insert synchronous information; and
adding an Ethernet header for Ethernet processing to each of the classified synchronous data, thereby forming a synchronous packet.

2. The method as claimed in claim 1, wherein the synchronous packet further comprises a header check sequence (HCS) for checking an error of the synchronous header and the Ethernet header.

3. The method as claimed in claim 1, wherein the synchronous packet further comprises a frame check sequence (FCS) used for detecting a transmission error in the synchronous packet.

4. The method as claimed in claim 1, wherein destination information of the synchronous data is included in the synchronous header.

5. The method as claimed in claim 1, wherein destination information of the synchronous data is included in the Ethernet header.

6. The method as claimed in claim 4, wherein routing of the synchronous frame is performed based on the destination information of the synchronous data obtained from analyzing header information included in each synchronous packet.

7. The method as claimed in claim 6, wherein each of the synchronous packets is transmitted through a unicast scheme according to the destinations.

8. A method for transmitting synchronous data and asynchronous data in a Residential Ethernet System, the method comprising the steps of:
packetizing synchronous data according to its destinations to be transmitted as a unicast scheme;
attaching a synchronous header to each of the packetized synchronous data in order to insert synchronous information into each synchronous data; and
providing an Ethernet header for Ethernet processing to each packetized synchronous data.

9. The method as claimed in claim 8, wherein the synchronous frame further comprises a header check sequence (HCS) for checking an error of the synchronous header and the Ethernet header.

10. The method as claimed in claim 8, wherein the synchronous frame further comprises a frame check sequence (FCS) used for detecting a transmission error in the synchronous packet.

11. The method as claimed in claim 8, wherein destination information of the synchronous data is included in the synchronous header.

12. The method as claimed in claim 8, wherein destination information of the synchronous data is included in the Ethernet header.

13. The method as claimed in claim 11, wherein routing of the synchronous frame is performed based on the destination information of the synchronous data obtained from analyzing header information.
